(19) United States
(12) Patent Application Publication
(10) Pub. No.: US 2026/0353010 A1
(43) Pub. Date: Nov. 5, 2026

(54) VIBRATION SOUND-PRODUCING UNIT, VIBRATION SOUND-PRODUCING MODULE AND ELECTRONIC DEVICE

(71) Applicant: Goertek Inc., Weifang (CN)

(72) Inventors: Guodong Zhao, Weifang (CN); Linlin Zhang, Weifang (CN); Jizong Wang, Weifang (CN)

(73) Assignee: Goertek Inc., Weifang (CN)

(21) Appl. No.: 19/486,219

(22) PCT Filed: Jan. 18, 2024
(86) PCT No.: PCT/CN2024/072979

§ 371 Date: Nov. 20, 2025

(30) Foreign Application Priority Data
May 23, 2023 (CN) 202310594030.9
Jun. 29, 2023 (CN) 202310785887.9

(51) Int. Cl. H04R 9/06; H04R 1/02; H04R 7/04; H04R 9/02; H04R 9/04

(52) U.S. Cl. CPC H04R 9/06; H04R 1/025; H04R 7/04; H04R 9/025; H04R 9/046; H04R 2400/03; H04R 2400/11

(57) ABSTRACT

The disclosed subject matter provides a vibration sound-producing unit, a vibration sound-producing module and an electronic device. The vibration sound-producing unit includes a stationary assembly, a first vibration system and a second vibration system, the stationary assembly includes a bracket and a magnetic circuit system fixed to the bracket, the magnetic circuit system has a magnetic gap, the first vibration system and the second vibration system are respectively provided on opposite sides of the stationary assembly and respectively fixed to opposite ends of the stationary assembly, the second vibration system includes an elastic connecting member and a vibrator assembly, two ends of the elastic connecting member are respectively connected to the vibrator assembly and a second end of the stationary assembly, the vibrator assembly includes a counterweight and a driving coil provided on the counterweight.

### CROSS-REFERENCE TO RELATED APPLICATIONS

The present application is a National Stage of International Application No. PCT/CN2024/072979, filed on Jan. 18, 2024, which claims priority to Chinese patent application No. 202310594030.9 filed with the CNIPA on May 23, 2023, and Chinese patent application No. 202310785887.9 filed with the CNIPA on Jun. 29, 2023, all of which are hereby incorporated by reference in their entireties.

### TECHNICAL FIELD

The present disclosure relates to the technical field of electroacoustic equipment, and particularly to a vibration sound-producing unit, a vibration sound-producing module and an electronic device.

### BACKGROUND

Smart terminal devices, especially mobile phone products, usually need to deliver both audio experience and vibration haptic feedback experience. Here, the audio experience comes from a sound-producing unit, and the vibration haptic feedback experience comes from a vibration unit.

In the related art, a vibration sound-producing module in which a sound-producing unit and a vibration unit are integrated as a single unit is proposed. Here, the sound-producing unit and the vibration unit are separately provided to respectively form independent control units, and the sound-producing unit and the vibration unit are stacked inside a housing of the vibration sound-producing module. Although the above structure can achieve the integration of the sound-producing unit and the vibration unit, the above vibration sound-producing module occupies too much assembly space, thereby affecting the compact and lightweight design of the terminal device.

Furthermore, the two ends of the elastic connecting member of the above vibration sound-producing module are respectively connected to the module housing and the vibrator assembly. When the model of the vibration sound-producing module changes, the vibration unit needs to adjust the structural design of the elastic connecting member according to the changes of the vibration sound-producing module, making it impossible to achieve modular and standardized design of the vibration sound-producing unit, thereby reducing production efficiency.

### SUMMARY

The present disclosure aims to solve at least one of the technical problems existing in the prior art. For this purpose, the present disclosure proposes a vibration sound-producing unit, wherein the vibration sound-producing unit has the advantages of a simple and compact structure and the ability to achieve modular and standardized design.

The present disclosure also proposes a vibration sound-producing module provided with the above vibration sound-producing unit.

The present disclosure further proposes an electronic device provided with the above vibration sound-producing module.

A vibration sound-producing unit according to an embodiment of a first aspect of the present disclosure, comprises: a stationary assembly comprising a bracket and a magnetic circuit system fixed to the bracket, the magnetic circuit system having a plurality of magnetic gaps which are coaxially arranged and sequentially spaced apart from inside to outside; a first vibration system and a second vibration system, the first vibration system and the second vibration system being respectively provided on opposite sides of the stationary assembly and respectively fixed to opposite ends of the stationary assembly, wherein, the first vibration system vibrates along a first direction, is fixed to a first end of the stationary assembly, and comprises a diaphragm assembly and a plurality of voice coils, one end of each voice coil being connected to the diaphragm assembly, and the other end of each voice coil being inserted into a corresponding one of the plurality of magnetic gaps in a one-to-one correspondence; the second vibration system vibrates along a second direction perpendicular to the first direction, and comprises an elastic connecting member and a vibrator assembly, two ends of the elastic connecting member being respectively connected to the vibrator assembly and a second end of the stationary assembly, the vibrator assembly comprising a counterweight and a driving coil provided on the counterweight, the magnetic circuit system being arranged corresponding to the driving coil to drive the vibrator assembly to vibrate.

In the vibration sound-producing unit according to an embodiment of the first aspect of the present disclosure, the magnetic circuit system is provided with magnetic gaps corresponding to the voice coils in the first vibration system, and the magnetic circuit system is also arranged corresponding to the driving coil of the second vibration system, thereby improving the magnetic field utilization rate of the magnetic circuit system, eliminating the need for a separate magnetic circuit system, and reducing production costs. Furthermore, the assembly space occupied by an additional magnetic circuit system can be saved, thus meeting the compact and slim design requirements of the vibration sound-producing unit. Moreover, the two ends of the elastic connecting member in the second vibration system are respectively connected to the vibrator assembly and the stationary assembly, enabling the vibration sound-producing unit to be formed as an independent functional unit, thereby achieving modular and standardized design of the vibration sound-producing unit and greatly enhancing its applicability.

According to some embodiments of the present disclosure, the two ends of the elastic connecting member are respectively connected to the vibrator assembly and the bracket, the bracket has a first mounting portion extending to the second end of the stationary assembly, and the elastic connecting member is fixedly connected to the first mounting portion.

According to some embodiments of the present disclosure, the two ends of the elastic connecting member are respectively connected to the vibrator assembly and the magnetic circuit system.

In some embodiments of the present disclosure, the magnetic circuit system comprises a magnetic yoke, and a center magnetic portion and a side magnetic portion respectively provided on the magnetic yoke, and the side magnetic portion is provided on an outer side of the center magnetic portion and is spaced apart from the center magnetic portion to define a magnetic gap.

In some embodiments of the present disclosure, the side magnetic portion comprises a side magnet and a side magnetic conduction plate provided on a side of the side magnet away from the second vibration system, the side magnetic conduction plate has a second mounting portion extending to the second end of the stationary assembly, and the elastic connecting member is fixedly connected to the second mounting portion; or, the elastic connecting member is fixedly connected to a side edge of the magnetic circuit system.

In some embodiments of the present disclosure, the elastic connecting member is connected to the magnetic yoke.

In some embodiments of the present disclosure, the magnetic yoke comprises a body portion and supporting frames provided at two ends of the body portion, one end of the elastic connecting member is connected to one of the supporting frames, and the other end of the elastic connecting member is connected to the counterweight.

In some embodiments of the present disclosure, the center magnetic portion comprises a first sub-center magnetic portion and a second sub-center magnetic portion, the second sub-center magnetic portion is provided on an outer side of the first sub-center magnetic portion and is spaced apart from the first sub-center magnetic portion to form a first sub-magnetic gap, the side magnetic portion is provided on an outer side of the second sub-center magnetic portion and is spaced apart from the second sub-center magnetic portion to form a second sub-magnetic gap, the plurality of voice coils comprise a first sub-voice coil and a second sub-voice coil, the first sub-voice coil is inserted into the first sub-magnetic gap, and the second sub-voice coil is inserted into the second sub-magnetic gap.

In some embodiments of the present disclosure, the first sub-center magnetic portion comprises a first center magnet, the second sub-center magnetic portion comprises a second center magnet provided on a periphery of the first center magnet, the side magnetic portion comprises a side magnet provided on a periphery of the second sub-center magnetic portion, the first center magnet, the second center magnet, and the side magnet are all magnetized along the first direction, and along the second direction, magnetization directions between the adjacent first center magnet and second center magnet and between the adjacent second center magnet and side magnet are opposite.

In some embodiments of the present disclosure, second center magnets at two ends of the first center magnet in the second direction are first magnets, second center magnets at two ends of the first center magnet in a third direction are second magnets, the third direction is perpendicular to both the first direction and the second direction, and a volume of the first magnet is greater than that of the second magnet.

In some embodiments of the present disclosure, the magnetic yoke comprises a body portion and a hollowed-out hole formed in the body portion, the hollowed-out hole is at least partially opposed to the driving coil along the first direction, the side magnetic portion and the second sub-center magnetic portion are both provided on the body portion, the first sub-center magnetic portion comprises a first center magnet and a first center magnetic conduction plate, the first center magnetic conduction plate comprises a supporting portion and an extension portion provided on an outer side of the supporting portion, at least part of the extension portion extends along the first direction, two ends of the extension portion are respectively connected to the supporting portion and the body portion, the supporting portion is opposed to the hollowed-out hole, and the first center magnet is provided on the supporting portion.

In some embodiments of the present disclosure, along a third direction perpendicular to both the first direction and the second direction, the extension portion is located on opposite sides of the supporting portion, and the second sub-center magnetic portion is spaced apart from the extension portion to define part of the first sub-magnetic gap.

In some embodiments of the present disclosure, the second sub-center magnetic portion comprises a second center magnet provided on a periphery of the first center magnet, second center magnets on two sides of the first sub-center magnetic portion in the third direction are provided on the body portion, and second center magnets on two sides of the first sub-center magnetic portion in the second direction are opposed to the hollowed-out hole along the first direction.

In some embodiments of the present disclosure, the second sub-center magnetic portion comprises a second center magnetic conduction plate provided on a side of the second center magnet away from the body portion, and the second center magnetic conduction plate is formed as a ring structure and is sleeved on an outer side of the supporting portion.

In some embodiments of the present disclosure, projections, along the first direction, of the first center magnet and the second center magnets located on two sides of the first sub-center magnetic portion in the second direction are located inside the perimeter of the hollowed-out hole.

In some embodiments of the present disclosure, along the first direction, the first center magnet and the second center magnets located on two sides of the first sub-center magnetic portion in the second direction both extend into the hollowed-out hole.

In some embodiments of the present disclosure, the driving coil has two connection edges arranged opposite to each other, and along the first direction, the two connection edges are respectively opposed to the first sub-center magnetic portion and the second sub-center magnetic portion; and/or, the two connection edges are respectively opposed to the second sub-center magnetic portion and the side magnetic portion.

A vibration sound-producing module according to an embodiment of a second aspect of the present disclosure, comprises a housing and the vibration sound-producing unit according to any of the above embodiments of the present disclosure, the vibration sound-producing unit is provided inside the housing, and a first end of the stationary assembly is connected to an inner wall of the housing.

In the vibration sound-producing module according to an embodiment of the second aspect of the present disclosure, by arranging the above vibration sound-producing unit, the first vibration system and the second vibration system of the vibration sound-producing unit share one magnetic circuit system, and the structure is relatively compact, thereby allowing an increase in the acoustic cavity volume of the vibration sound-producing module; moreover, the elastic connecting member of the above vibration sound-producing unit is respectively connected to the stationary assembly and the vibrator assembly, whereby modular and standardized design can be achieved, thus improving the assembly efficiency of the vibration sound-producing module.

An electronic device according to an embodiment of a third aspect of the present disclosure, comprises the vibration sound-producing module according to any of the above embodiments of the present disclosure.

In the electronic device according to an embodiment of the third aspect of the present disclosure, by arranging the above vibration sound-producing module, the vibration sound-producing module has a compact structural design, occupies a small assembly space, and further has good sound-producing effects and vibration effects, thereby meeting the lightweight and slim design requirements of the electronic device. Furthermore, it is also possible to enable the electronic device to have both good sound quality and vibration feedback effects, enhancing the product market competitiveness of the electronic device.

Additional aspects and advantages of the present disclosure will be given in part in the following description, will become apparent in part from the following description, or will be learned through the practice of the present disclosure.

### BRIEF DESCRIPTION OF THE DRAWINGS

The above and/or additional aspects and advantages of the present disclosure will become apparent and readily understood from the description of the embodiments in conjunction with the following drawings, wherein:

FIG. 1 is an exploded structural schematic diagram of a vibration sound-producing unit according to an embodiment of the present disclosure;

FIG. 2 is an exploded structural schematic diagram of a vibration sound-producing unit according to another embodiment of the present disclosure;

FIG. 3 is an exploded structural schematic diagram of a vibration sound-producing unit according to yet another embodiment of the present disclosure;

FIG. 4 is an exploded structural schematic diagram of a vibration sound-producing unit according to still another embodiment of the present disclosure;

FIG. 5 is a vertical cross-sectional view of a vibration sound-producing unit along a second direction according to an embodiment of the present disclosure;

FIG. 6 is a vertical cross-sectional view of a vibration sound-producing unit along the second direction according to another embodiment of the present disclosure;

FIG. 7 is a vertical cross-sectional view of a vibration sound-producing unit along the second direction according to still another embodiment of the present disclosure;

FIG. 8 is a vertical cross-sectional view of a vibration sound-producing unit along a third direction according to an embodiment of the present disclosure;

FIG. 9 is a vertical cross-sectional view of a vibration sound-producing unit along the third direction according to another embodiment of the present disclosure;

FIG. 10 is a vertical cross-sectional view of a vibration sound-producing unit along the third direction according to yet another embodiment of the present disclosure;

FIG. 11 is a vertical cross-sectional view of a vibration sound-producing unit along the third direction according to still another embodiment of the present disclosure;

FIG. 12 is a structural schematic diagram of a vibration sound-producing unit from a first viewing angle according to an embodiment of the present disclosure;

FIG. 13 is a structural schematic diagram of a vibration sound-producing unit from another viewing angle according to an embodiment of the present disclosure;

FIG. 14 is a partial structural schematic diagram of a vibration sound-producing unit according to an embodiment of the present disclosure;

FIG. 15 is another partial structural schematic diagram of a vibration sound-producing unit according to an embodiment of the present disclosure;

FIG. 16 is a structural schematic diagram showing the cooperation between a bracket and an elastic connecting member of a vibration sound-producing unit according to an embodiment of the present disclosure;

FIG. 17 is a vertical cross-sectional view of a vibration sound-producing unit along the second direction according to an embodiment of the present disclosure;

FIG. 18 is a structural schematic diagram of a vibration sound-producing module according to an embodiment of the present disclosure.

### DESCRIPTION OF REFERENCE SIGNS

Vibration sound-producing unit 100,
Magnetic circuit system 1, magnetic gap 1a, spacing portion 1b, first sub-magnetic gap 1c, second sub-magnetic gap 1d, center magnetic portion 11, first sub-center magnetic portion 11a, second sub-center magnetic portion 11b, center magnet 110, first sub-center magnet 111, second sub-center magnet 112, center magnetic conduction plate 113, first center magnetic conduction plate 113a, supporting plate 1131a, extension plate 1132a, second center magnetic conduction plate 113b, first center magnet 114, second center magnet 115, first magnet 115a, second magnet 115b, supporting portion 1131, extension portion 1132, side magnetic portion 12, side magnet 121, side magnetic conduction plate 122, first plate body 1221, second plate body 1222, recessed portion 122a, magnetic yoke 13, body portion 131, hollowed-out hole 132, supporting frame 133,
First vibration system 2, diaphragm assembly 21, diaphragm 211, dome 212, voice coil 22, first sub-voice coil 22a, second sub-voice coil 22b,
Second vibration system 3, elastic connecting member 31, first elastic connection portion 311, second elastic connection portion 312, vibrator assembly 32, counterweight 321, assembly groove 321a, driving coil 322, long side 3221, short side 3222,
Bracket 4, first mounting portion 41,
Basket 5,
Vibration sound-producing module 200, housing 201.

### DETAILED DESCRIPTION

The embodiments of the present disclosure are described in detail below, examples of which are shown in the drawings, wherein the same or similar reference numerals throughout denote the same or similar components or components having the same or similar functions. The embodiments described below with reference to the drawings are exemplary and are intended to explain the present disclosure, but should not be construed as limiting the present disclosure.

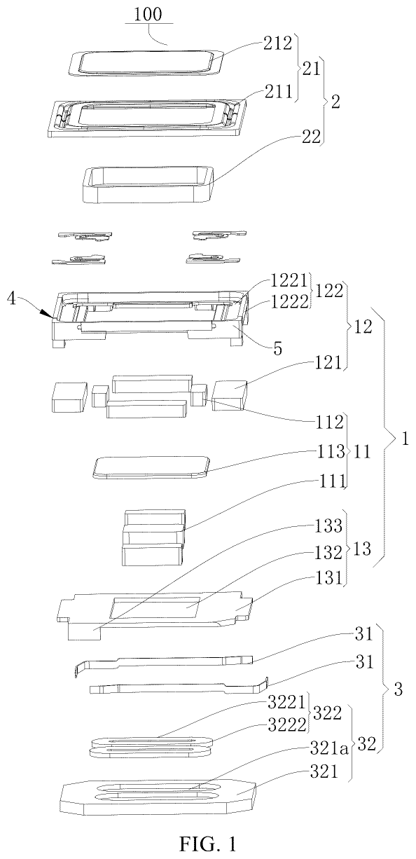

Below, with reference to FIGS. 1-17, the vibration sound-producing unit 100 according to embodiments of the first aspect of the present disclosure is described in detail. This vibration sound-producing unit 100 can be a speaker unit that combines both sound-producing and vibration functions.

As shown in FIGS. 1-4, the vibration sound-producing unit 100 according to an embodiment of the first aspect of the present disclosure comprises: a stationary assembly, a first vibration system 2, and a second vibration system 3.

Here, the stationary assembly can comprise a bracket 4 and a magnetic circuit system 1 fixed to the bracket 4, and the magnetic circuit system 1 has a magnetic gap 1a. The first vibration system 2 and the second vibration system 3 are respectively provided on opposite sides of the stationary assembly and are respectively fixed to opposite ends of the stationary assembly. The first vibration system 2 can vibrate along a first direction, is fixed to a first end of the stationary assembly, and can comprise a diaphragm assembly 21 and a voice coil 22. One end of the voice coil 22 is connected to the diaphragm assembly 21, and the other end of the voice coil 22 is inserted into the magnetic gap 1a. For example, the first direction can be the vertical z-direction, meaning the voice coil 22 can reciprocate along the vertical direction driven by magnetic force, thereby driving the diaphragm assembly 21 to vibrate and produce sound, realizing the sound-producing function of the vibration sound-producing unit 100. In a specific example of the present disclosure, the diaphragm assembly 21 can comprise a diaphragm 211 and a dome 212. The diaphragm 211 is connected to the bracket 4, the dome 212 is provided on the diaphragm 211, and the end of the voice coil 22 away from the magnetic circuit system 1 is connected to the dome 212.

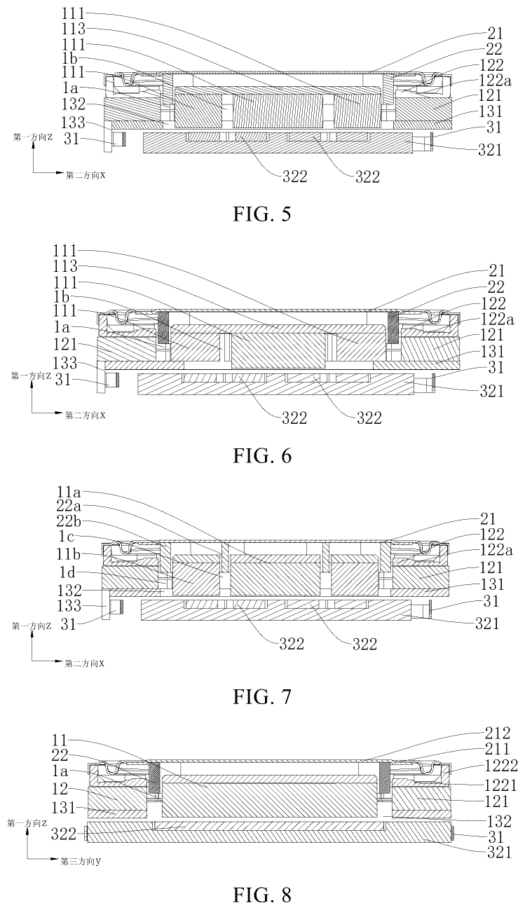

As shown in FIGS. 5-7, the second vibration system 3 can vibrate along a second direction perpendicular to the first direction, and can comprise an elastic connecting member 31 and a vibrator assembly 32. Two ends of the elastic connecting member 31 are respectively connected to the vibrator assembly 32 and a second end of the stationary assembly. The vibrator assembly 32 comprises a counterweight 321 and a driving coil 322 provided on the counterweight 321. The magnetic circuit system 1 is arranged corresponding to the driving coil 322 to drive the vibrator assembly 32 to vibrate.

Specifically, the first vibration system 2 can vibrate along the vertical z-direction, and the second vibration system 3 can vibrate along the horizontal x-direction. The magnetic circuit system 1 is provided with a magnetic gap 1a corresponding to the first vibration system 2. The end of the voice coil 22 in the first vibration system 2 away from the diaphragm assembly 21 can be inserted into the magnetic gap 1a. Thereby, the magnetic circuit system 1 can drive the first vibration system 2 to vibrate along the first direction. Furthermore, the magnetic circuit system 1 is also arranged corresponding to the driving coil 322 of the second vibration system 3, meaning the magnetic circuit system 1 can also drive the driving coil 322 to actuate the counterweight 321 to vibrate along the second direction, thereby realizing the vibration of the second vibration system 3 along the second direction.

Here, one end of the elastic connecting member 31 of the second vibration system 3 is connected to the vibrator assembly 32, and the other end of the elastic connecting member 31 is connected to the stationary assembly. That is to say, the other end of the elastic connecting member 31 can be connected to the bracket 4, or can be connected to the magnetic circuit system 1. It needs to be explained that the bracket 4 can be a separate component provided independently of the magnetic circuit system 1, and the bracket can also be formed as an extension of a part of the magnetic circuit system 1, meaning the bracket can also be formed integrally with the magnetic circuit system 1. Alternatively, the bracket 4 is formed jointly by a part extended from the magnetic circuit system 1 and a plastic material component (basket 5) injection molded onto the magnetic circuit system. It can be selected and set according to actual design and usage requirements, which will not be specifically limited by the present disclosure.

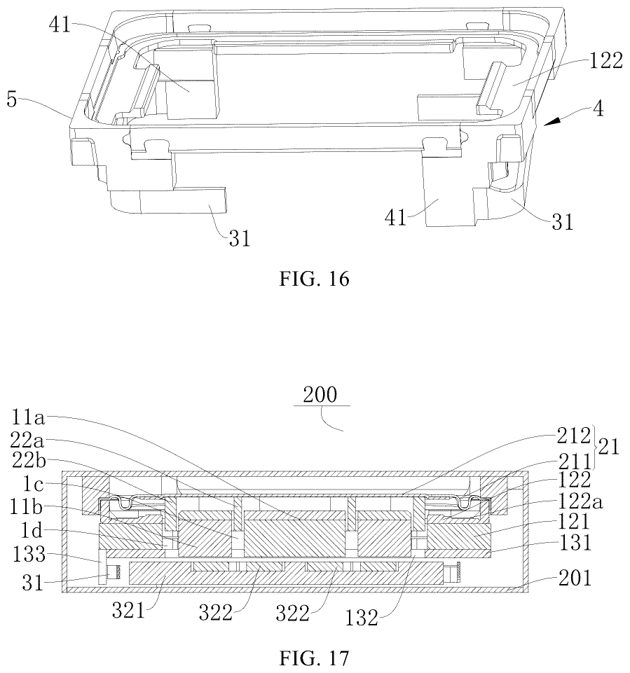

For example, as shown in FIG. 16, the magnetic circuit system 1 can comprise a side magnetic portion 12. The side magnetic conduction plate 122 of the side magnetic portion 12 comprises a first plate body 1221 extending along the second direction and a second plate body 1222 extending along the first direction. The basket 5 of the vibration sound-producing unit 100 is a plastic material component. The basket 5 is integrally injection molded with the side magnetic conduction plate 122. The basket 5 is connected to the second plate body 1222. The basket 5 of the vibration sound-producing unit 100 forms the bracket 4. Here, one end of the elastic connecting member 31 is connected to the vibrator assembly 32, and the other end of the elastic connecting member 31 is integrally injection molded with the bracket 4 of the vibration sound-producing unit 100.

It can be understood that typically part of the magnetic field of the magnetic circuit system 1 of the speaker is used to drive the voice coil 22 to vibrate and produce sound. The present disclosure, by providing the magnetic gap 1a corresponding to the first vibration system 2 in the magnetic circuit system 1 and also arranging the magnetic circuit system 1 corresponding to the driving coil 322 of the second vibration system 3, eliminates the need for an additional magnetic circuit system 1, and reduces production costs. Furthermore, the assembly space occupied by an additional magnetic circuit system 1 can be saved, thereby meeting the compact and slim design requirements of the vibration sound-producing unit 100.

Moreover, the two ends of the elastic connecting member 31 in the second vibration system 3 are respectively connected to the vibrator assembly 32 and the stationary assembly. Both the vibrator assembly 32 and the stationary assembly are components of the vibration sound-producing unit 100. Thereby, the vibration sound-producing unit 100 can be formed as an independent functional unit. That is, since the vibration sound-producing unit 100 is configured as a complete and independent functional unit that can be fixed inside the housing 201 of the vibration sound-producing module 200, any change in the model of the vibration sound-producing module 200 requires only an adjustment to the size and shape of its housing 201, without needing to change the vibration sound-producing unit 100, thereby achieving modular and standardized design of the vibration sound-producing unit 100 and greatly enhancing its applicability.

According to the vibration sound-producing unit 100 of the embodiment of the first aspect of the present disclosure, the magnetic circuit system 1 is provided with the magnetic gap 1a corresponding to the voice coil 22 in the first vibration system 2, and the magnetic circuit system 1 is also arranged corresponding to the driving coil 322 of the second vibration system 3. Thereby, it is possible to improve the magnetic field utilization rate of the magnetic circuit system 1, eliminate the need for an additional magnetic circuit system 1, and reduce production costs. Furthermore, the assembly space occupied by an additional magnetic circuit system 1 can be saved, thus meeting the compact and slim design requirements of the vibration sound-producing unit 100. Moreover, the two ends of the elastic connecting member 31 in the second vibration system 3 are respectively connected to the vibrator assembly 32 and the stationary assembly, enabling the vibration sound-producing unit 100 to be formed as an independent functional unit, thereby achieving modular and standardized design of the vibration sound-producing unit 100 and greatly enhancing its applicability.

As shown in FIG. 16, according to some embodiments of the present disclosure, the two ends of the elastic connecting member 31 are respectively connected to the vibrator assembly 32 and the bracket 4. The bracket 4 has a first mounting portion 41 extending to the second end of the stationary assembly, and the elastic connecting member 31 is fixedly connected to the first mounting portion 41. Thereby, the vibration sound-producing unit 100 can achieve modular and standardized design. Specifically, the first mounting portion 41 of the bracket 4 can suspend the vibrator assembly 32 via the elastic connecting member 31, and under the action of the magnetic force from the magnetic circuit system 1, the driving coil 322 can smoothly actuate the counterweight 321 to vibrate along the second direction.

According to some embodiments of the present disclosure, the two ends of the elastic connecting member 31 can be respectively connected to the vibrator assembly 32 and the magnetic circuit system 1. Thereby, not only can the modular and standardized design of the vibration sound-producing unit 100 be achieved, but also the structural design of the vibration sound-producing unit 100 can be simplified. The magnetic circuit system 1 can suspend the vibrator assembly 32 by connecting with the elastic connecting member 31.

As shown in FIGS. 5-7, according to some embodiments of the present disclosure, the magnetic circuit system 1 can comprise a magnetic yoke 13, and a center magnetic portion 11 and a side magnetic portion 12 respectively provided on the magnetic yoke 13. The side magnetic portion 12 is provided on an outer side of the center magnetic portion 11 and is spaced apart from the center magnetic portion 11 to define a magnetic gap 1a. The side of the voice coil 22 away from the diaphragm assembly 21 can be inserted into the magnetic gap 1a. Thereby, under the action of the magnetic field lines in the magnetic gap 1a, the voice coil 22 can actuate the diaphragm assembly 21 to vibrate along the first direction.

In some embodiments of the present disclosure, the side magnetic portion 12 can comprise a side magnet 121 and a side magnetic conduction plate 122 provided on a side of the side magnet 121 away from the second vibration system 3. The side magnetic conduction plate 122 has a second mounting portion (not shown in the figures) extending to the second end of the stationary assembly, and the elastic connecting member 31 is fixedly connected to the second mounting portion. Thereby, the side magnetic conduction plate 122 can not only function to gather the magnetic field lines in the side magnetic portion 12, but also can be used to fix the elastic connecting member 31, thus simplifying the structural design of the vibration sound-producing unit 100 and making the structural design of the vibration sound-producing unit 100 more compact.

In other embodiments of the present disclosure, the elastic connecting member 31 can also be fixedly connected to a side edge of the magnetic circuit system 1. For example, the elastic connecting member 31 can be fixedly connected to a side edge of the side magnet 121, or can be fixedly connected to a side edge of the side magnetic conduction plate 122. Thereby, it is possible to simplify the structural design of the vibration sound-producing unit 100, making the structural design of the vibration sound-producing unit 100 more compact.

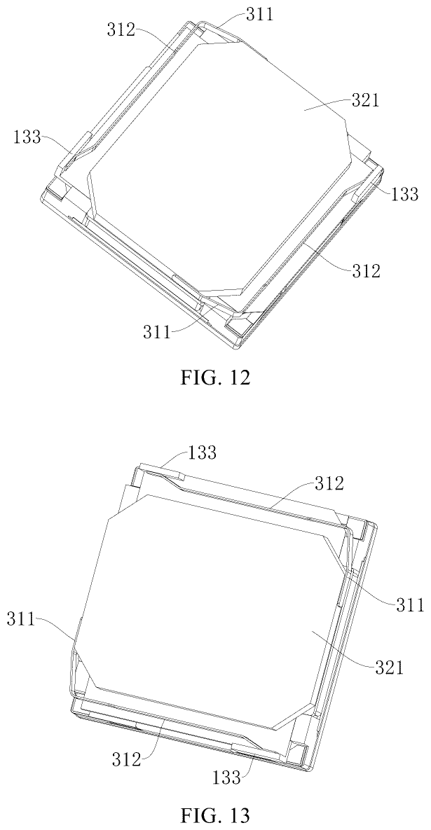

As shown in FIGS. 12-13, in some embodiments of the present disclosure, the elastic connecting member 31 is connected to the magnetic yoke 13. It can be understood that the magnetic yoke 13 is provided on a side of the magnetic circuit system 1 close to the vibrator assembly 32. By arranging the elastic connecting member 31 to be connected to the magnetic yoke 13, it is thus possible to facilitate the fixation of the elastic connecting member 31, making practical operation more convenient.

In some embodiments of the present disclosure, the magnetic yoke 13 can comprise a body portion 131 and supporting frames 133 provided at two ends of the body portion 131. One end of the elastic connecting member 31 is connected to the supporting frame 133, and the other end of the elastic connecting member 31 is connected to the counterweight 321. Thereby, the body portion 131 can be used to support the center magnetic portion 11 and the side magnetic portion 12, and the supporting frame 133 can be used to support and connect the elastic connecting member 31, resulting in a relatively reasonable structural design.

In the specific example shown in FIGS. 12-13, the supporting frame 133 can be formed as a plate-like structure. One end of the supporting frame 133 is connected to the body portion 131, and the other end of the supporting frame 133 extends along the first direction away from the body portion 131. Thereby, the supporting frame 133 can define an installation space for the elastic connecting member 31, facilitating the installation and fixation of the elastic connecting member 31. Optionally, the supporting frame 133 and the body portion 131 can be formed as an integrally molded structure, such as an integral stamping part, etc. Alternatively, the supporting frame 133 and the body portion 131 can be formed as separate structures, and can be fixed together by means such as welding. Optionally, the supporting frame 133 and the body portion 131 can be made of the same material, or can be made of different materials. For example, the body portion 131 can be made of a high magnetic permeability material (such as cobalt alloy material), and the supporting frame 133 can be made of metal material, plastic material, etc.

In a specific embodiment of the present disclosure, the body portion 131 can be formed as a rectangular structure. The supporting frames 133 are two in number and are respectively provided at diagonal positions of the body portion 131. Thereby, the two elastic connecting members 31 can form a corresponding installation structure, making the force on the vibrator assembly 32 more balanced and improving the operational stability of the second vibration system 3.

As shown in FIGS. 12-13, in an embodiment of the present disclosure, the elastic connecting member 31 is provided with a first elastic connection portion 311 extending along the second direction and a second elastic connection portion 312 extending along a third direction. The third direction is perpendicular to both the first direction and the second direction. Here, one of the first elastic connection portion 311 and the second elastic connection portion 312 is connected to the supporting frame 133, and the other of the first elastic connection portion 311 and the second elastic connection portion 312 is connected to the counterweight 321.

Specifically, the first direction can be the vertical z-direction, the second direction can be the horizontal x-direction, and the third direction can be the horizontal y-direction. The third direction is perpendicular to both the first direction and the second direction. Here, each elastic connecting member 31 includes a first elastic connection portion 311 and a second elastic connection portion 312 arranged at an angle. The first elastic connection portion 311 extends along the second direction, and the second elastic connection portion 312 extends along the third direction. One of the first elastic connection portion 311 and the second elastic connection portion 312 is connected to the supporting frame 133, and the other of the first elastic connection portion 311 and the second elastic connection portion 312 is connected to the counterweight 321. Thereby, both the first elastic connection portion 311 and the second elastic connection portion 312 can buffer the vibrator assembly 32, thus ensuring the stable operation of the second vibration system 3.

As shown in FIG. 17, in some embodiments of the present disclosure, the magnetic circuit system 1 can comprise a center magnetic portion 11 and a side magnetic portion 12. The side magnetic portion 12 is provided on an outer side of the center magnetic portion 11 and is spaced apart from the center magnetic portion 11 to define a magnetic gap 1a. The center magnetic portion 11 comprises a center magnet 110, and the side magnetic portion 12 comprises a side magnet 121. The driving coil 322 can have two long sides 3221 arranged opposite to each other, and along the first direction, the two long sides 3221 are respectively opposed to the center magnet 110 and the side magnet 121. Thereby, the center magnetic portion 11 and the side magnetic portion 12 can not only form the magnetic gap 1a arranged corresponding to the first vibration system 2, but the magnetic circuit system 1 can also simultaneously act on the driving coil 322 in the second vibration system 3, realizing a structural design where the first vibration system 2 and the second vibration system 3 share one magnetic circuit system 1.

As shown in FIGS. 5-6, in some embodiments of the present disclosure, the center magnetic portion 11 comprises a plurality of first sub-center magnets 111 spaced apart along the second direction. The magnetization directions of two adjacent first sub-center magnets 111 are opposite. The driving coil 322 has two long sides 3221 arranged opposite to each other, and along the first direction, the two long sides 3221 are respectively opposed to two adjacent first sub-center magnets 111. Specifically, typically the magnetic field utilization rate of the center magnetic circuit portion of a speaker is low. The present disclosure, by arranging the center magnetic portion 11 to have a plurality of first sub-center magnets 111 spaced apart along the second direction, and arranging the two long sides 3221 of the driving coil 322 along the first direction to be respectively opposed to two adjacent first sub-center magnets 111, can utilize the portion of the magnetic field in the center magnetic portion 11 that has low utilization in the first vibration system 2 as the magnetic field for the second vibration system 3, which can improve the magnetic field utilization rate of the center magnetic portion 11, eliminate the need for an additional magnetic circuit system 1, and reduce production costs.

As shown in FIGS. 5-6, in some embodiments of the present disclosure, there are at least three first sub-center magnets 111. Two adjacent first sub-center magnets 111 are spaced apart to form a spacing portion 1b. The number of driving coils 322 is the same as the number of spacing portions 1b, and the center holes of the driving coils 322 are arranged in one-to-one correspondence with the spacing portions 1b. Specifically, the driving coil 322 can be formed in a flat shape. The two long sides 3221 of the driving coil 322 are provided on opposite sides of the center hole. The number of driving coils 322 is the same as the number of spacing portions 1b, so as to ensure that one driving coil 322 is provided between every two adjacent first sub-center magnets 111. Thereby, through the above arrangement, each driving coil 322 corresponds to a pair of spaced first sub-center magnets 111, and the first long side 3221 and the second long side 3221 can fully cut the magnetic field lines, thereby improving the vibration effect of the vibrator assembly 32.

In a specific example of the present disclosure, the driving coil 322 can further comprise two short sides 3222 arranged opposite to each other. The two short sides 3222 are provided on two sides of the long sides 3221 in the length direction, and each end of each short side 3222 is connected to a long side 3221. Thereby, the two short sides 3222 and the two long sides 3221 cooperatively define the center hole, and along the first direction, each center hole is arranged in one-to-one correspondence with each spacing portion 1b.

As shown in FIGS. 5-6, in some embodiments of the present disclosure, the side magnetic portion 12 can comprise a side magnet 121. Both the side magnet 121 and the plurality of first sub-center magnets 111 are magnetized along the first direction, and the magnetization directions between the adjacent side magnet 121 and first sub-center magnet 111, and between two adjacent first sub-center magnets 111, are all opposite. For example, the first direction can be the vertical z-direction, meaning both the side magnet 121 and the plurality of first sub-center magnets 111 are magnetized along the vertical direction. One of between the adjacent side magnet 121 and first sub-center magnet 111, and between two adjacent first sub-center magnets 111, is magnetized from top to bottom, and the other of the adjacent side magnet 121 and first sub-center magnet 111, and the other of between the adjacent side magnet 121 and first sub-center magnet 111, and between two adjacent first sub-center magnets 111, is magnetized from bottom to top. Thereby, through the above arrangement, it is possible for the voice coil 22 to fully cut the magnetic field lines in the magnetic gap 1a formed between the side magnetic portion 12 and the center magnetic portion 11, and also possible for the driving coil 322 to fully cut the magnetic field lines formed between two adjacent first sub-center magnets 111, ensuring the sound-producing and vibration effects of the vibration sound-producing unit 100.

As shown in FIGS. 5-6, in some embodiments of the present disclosure, the center magnetic portion 11 further comprises a center magnetic conduction plate 113. The sides of the plurality of first sub-center magnets 111 away from the second vibration system 3 are all connected to the center magnetic conduction plate 113. The center magnetic conduction plate 113 can not only function to gather magnetic field lines, but can also assemble the plurality of first sub-center magnets 111 together, facilitating the installation and fixation of the plurality of first sub-center magnets 111.

As shown in FIG. 6, in some embodiments of the present disclosure, the magnetic yoke 13 comprises a body portion 131 and a hollowed-out hole 132 formed in the body portion 131. The side magnetic portion 12 and the first sub-center magnets 111 located at the two ends are all provided on the body portion 131. Along the first direction, the hollowed-out hole 132 is at least partially opposed to the driving coil 322. Specifically, one end of the plurality of first sub-center magnets 111 can be connected to the center magnetic conduction plate 113, and the other end of the first sub-center magnets 111 located at the two ends is fixed to the body portion 131. Thereby, the magnetic yoke 13 can not only fix the side magnetic portion 12 and the center magnetic portion 11, but also can have a magnetic gathering effect, ensuring the magnetic field strength corresponding to the first vibration system 2. By providing the hollowed-out hole 132 on the body portion 131, the hollowed-out hole 132 can be opposed to part of the driving coil 322 or the entire driving coil 322, thereby ensuring that the driving coil 322 can successfully cut the magnetic field lines, thus ensuring the vibration effect of the second vibration system 3.

Optionally, there can be a plurality of driving coils 322 and one hollowed-out hole 132. The hollowed-out hole 132 is arranged corresponding to the plurality of driving coils 322, thereby simplifying the processing procedure of the hollowed-out hole 132 and improving processing efficiency. Optionally, there can be a plurality of driving coils 322 and also a plurality of hollowed-out holes 132, and the plurality of hollowed-out holes 132 are arranged in one-to-one correspondence with the plurality of driving coils 322, thereby relatively reducing the opening area of the magnetic yoke 13, which can not only improve the structural strength of the magnetic yoke 13 but also improve its magnetic gathering effect.

In some embodiments of the present disclosure, the projections along the first direction of the other first sub-center magnets 111 located between the first sub-center magnets 111 at the two ends are all located inside the perimeter of the hollowed-out hole 132, thereby ensuring the number of magnetic field lines passing through the hollowed-out hole 132 and thus ensuring the vibration effect of the second vibration system 3.

Furthermore, along the first direction, the other first sub-center magnets 111 located between the first sub-center magnets 111 at the two ends all extend into the hollowed-out hole 132, thereby reducing the distance between the center magnetic portion 11 and the driving coil 322, thus increasing the strength of the magnetic field lines acting on the driving coil 322, and thereby improving the vibration effect of the second vibration system 3.

In some embodiments of the present disclosure, a part of the first sub-center magnets 111 located at the two ends can be provided on the body portion 131, and another part of the first sub-center magnets 111 located at the two ends is opposed to the hollowed-out hole 132, thereby ensuring the number of magnetic field lines passing through the hollowed-out hole 132 and thus ensuring the vibration effect of the second vibration system 3.

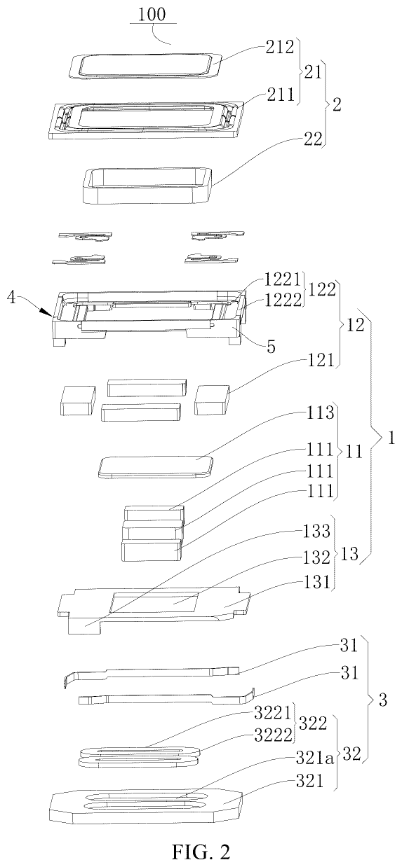

Below, the vibration sound-producing unit 100 according to a specific embodiment of the present disclosure is described in detail with reference to FIGS. 2, 6, and 8.

As shown in FIGS. 2, 6, and 8, the vibration sound-producing unit 100 comprises: a magnetic circuit system 1, a first vibration system 2, and a second vibration system 3.

Here, the first vibration system 2 and the second vibration system 3 are respectively provided on opposite sides of the magnetic circuit system 1. The magnetic circuit system 1 comprises a magnetic yoke 13, and a center magnetic portion 11 and a side magnetic portion 12 provided on the magnetic yoke 13. The side magnetic portion 12 is provided on an outer side of the center magnetic portion 11, and the center magnetic portion 11 and the side magnetic portion 12 are spaced apart to define a magnetic gap 1a. The center magnetic portion 11 comprises three first sub-center magnets 111 and a center magnetic conduction plate 113, the three first sub-center magnets 111 are spaced apart along the second direction (horizontal x-direction), the end of each first sub-center magnet 111 away from the second vibration system 3 is connected to the center magnetic conduction plate 113, and two adjacent first sub-center magnets 111 are spaced apart to form a spacing portion 1b. The side magnetic portion 12 comprises a side magnet 121 and a side magnetic conduction plate 122 provided on a side of the side magnet 121 away from the second vibration system 3. Here, both the side magnet 121 and the plurality of first sub-center magnets 111 are magnetized along the first direction, and the magnetization directions between the adjacent side magnet 121 and first sub-center magnet 111, and between two adjacent first sub-center magnets 111, are all opposite. The magnetic yoke 13 comprises a body portion 131 and a hollowed-out hole 132 formed in the body portion 131. The side magnet 121 and the first sub-center magnets 111 located at the two ends are all provided on the body portion 131. Along the first direction (vertical z-direction), the first sub-center magnet 111 located in the middle position extends into the hollowed-out hole 132.

The first vibration system 2 vibrates along the first direction, and comprises a diaphragm assembly 21 and a voice coil 22. The diaphragm assembly 21 comprises a diaphragm 211 and a dome 212 provided on the diaphragm 211. One end of the voice coil 22 is fixed to the dome 212, and the other end of the voice coil 22 is inserted into the magnetic gap 1a. The side magnetic conduction plate 122 comprises a horizontally extending first plate body 1221 and a vertically extending second plate body 1222. The first plate body 1221 is provided on a side of the side magnet 121 away from the second vibration system 3. One end of the second plate body 1222 is connected to the first plate body 1221, and the other end of the second plate body 1222 extends along the first direction. Both ends of the diaphragm 211 are fixed to the second plate body 1222. The second plate body 1222 can be integrally injection molded with the plastic basket 5 of the vibration sound-producing unit 100, meaning the second plate body 1222 can serve as part of the bracket 4, and the edge of the diaphragm 211 can be fixed to the bracket 4. Here, the corrugation portion of the diaphragm 211 extends along the first direction towards the side close to the side magnetic portion 12. The first plate body 1221 is provided with a recessed portion 122a arranged corresponding to the corrugation portion.

The second vibration system 3 vibrates along the second direction, and comprises an elastic connecting member 31 and a vibrator assembly 32. The body portion 131 of the magnetic yoke 13 is formed as a rectangular structure. A pair of diagonal positions of the body portion 131 is provided with supporting frames 133, which is formed as a plate-like structure, is connected to the body portion 131 at one end thereof, and extends along the first direction away from the body portion 131 at the other end thereof. The two ends of the elastic connecting member 31 are respectively connected to the vibrator assembly 32 and the supporting frame 133. Thereby, the magnetic circuit system 1 can suspend the vibrator assembly 32. The vibrator assembly 32 comprises a counterweight 321 and two driving coils 322 provided on the counterweight 321. Each driving coil 322 has two long sides 3221 arranged opposite to each other and two short sides 3222 arranged opposite to each other. The two short sides 3222 are provided on two sides along the length direction of the long sides 3221. Each end of each short side 3222 is connected to a long side 3221. Thereby, the two short sides 3222 and the two long sides 3221 cooperatively define a center hole, and along the first direction, each center hole is arranged in one-to-one correspondence with each spacing portion 1b, and the two long sides 3221 are respectively opposed to two adjacent first sub-center magnets 111.

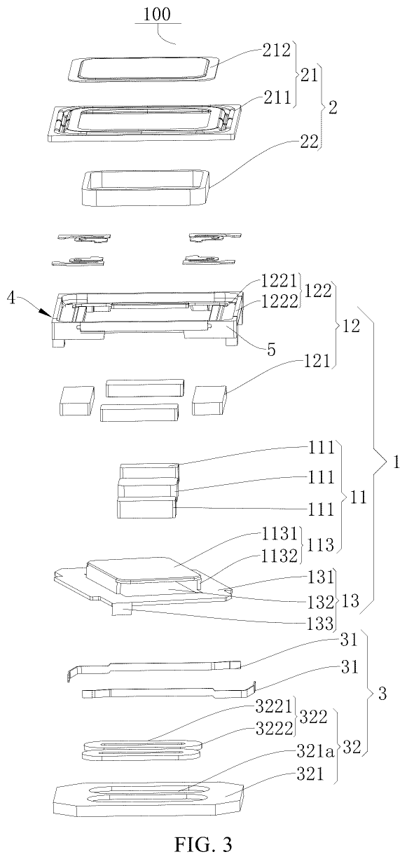

As shown in FIGS. 3 and 10, in some embodiments of the present disclosure, the center magnetic portion 11 can further comprise a center magnetic conduction plate 113. The sides of the plurality of first sub-center magnets 111 away from the second vibration system 3 are all connected to the center magnetic conduction plate 113. The magnetic yoke 13 comprises a body portion 131 and a hollowed-out hole 132 formed in the body portion 131. The side of the side magnetic portion 12 close to the second vibration system 3 is provided on the body portion 131. The center magnetic conduction plate 113 can comprise a supporting portion 1131 and an extension portion 1132 provided on an outer side of the supporting portion 1131. The extension portion 1132 extends along the first direction. Two ends of the extension portion 1132 are respectively connected to the supporting portion 1131 and the body portion 131. The supporting portion 1131 is opposed to the hollowed-out hole 132. The plurality of first sub-center magnets 111 are all fixed to the supporting portion 1131.

Specifically, the center magnetic conduction plate 113 can not only function to gather magnetic field lines, but can also assemble the plurality of first sub-center magnets 111 together. The center magnetic conduction plate 113 comprises a supporting portion 1131 extending along the second direction and an extension portion 1132 extending along the first direction. One end of the plurality of first sub-center magnets 111 can be connected to the supporting portion 1131. The two ends of the extension portion 1132 are respectively connected to the supporting portion 1131 and the body portion 131. Thereby, the magnetic yoke 13 can not only support the side magnetic portion 12, but can also support the center magnetic portion 11 through the extension portion 1132. The hollowed-out hole 132 is formed in the body portion 131 of the magnetic yoke 13. The other end of the plurality of first sub-center magnets 111 can be opposed to the hollowed-out hole 132. The hollowed-out hole 132 can be opposed to part of the driving coil 322 or the entire driving coil 322, thereby ensuring that the driving coil 322 can successfully cut the magnetic field lines, thus ensuring the vibration effect of the second vibration system 3.

As shown in FIG. 3, in some embodiments of the present disclosure, along a third direction perpendicular to both the first direction and the second direction, the extension portions 1132 are located on opposite sides of the supporting portion 1131. The side magnetic portion 12 is spaced apart from the extension portions 1132 to define a part of the magnetic gap 1a. Specifically, the second direction and the third direction can be in the same horizontal plane. For example, the second direction can be the horizontal x-direction, the third direction can be the horizontal y-direction, and the first direction can be the vertical z-direction. Here, the extension portions 1132 can be two in number, and the two extension portions 1132 can be provided on two sides of the supporting portion 1131 in the third direction, thereby connecting the supporting portion 1131 and the magnetic yoke 13 together, resulting in a relatively simple structural design. Here, the side magnetic portion 12 can be spaced apart from the extension portions 1132 to define a part of the magnetic gap 1a, and can also be spaced apart from the first sub-center magnets 111 located at the two ends and the center magnetic conduction plate 113 to define another part of the magnetic gap 1a.

In some embodiments of the present disclosure, the projections along the first direction of the plurality of first sub-center magnets 111 are all located inside the perimeter of the hollowed-out hole 132, thereby ensuring the number of magnetic field lines passing through the hollowed-out hole 132 and thus ensuring the vibration effect of the second vibration system 3.

Furthermore, along the first direction, the plurality of first sub-center magnets 111 all extend into the hollowed-out hole 132, thereby reducing the distance between the center magnetic portion 11 and the driving coil 322, thus increasing the strength of the magnetic field lines acting on the driving coil 322, and thereby improving the vibration effect of the second vibration system 3.

Below, the vibration sound-producing unit 100 according to a specific embodiment of the present disclosure is described in detail with reference to FIGS. 3, 5, and 10.

As shown in FIGS. 3, 5, and 10, the vibration sound-producing unit 100 comprises: a magnetic circuit system 1, a first vibration system 2, and a second vibration system 3.

Here, the first vibration system 2 and the second vibration system 3 are respectively provided on two opposite sides of the magnetic circuit system 1. The magnetic circuit system 1 comprises a magnetic yoke 13, and a center magnetic portion 11 and a side magnetic portion 12 provided on the magnetic yoke 13. The side magnetic portion 12 is provided on an outer side of the center magnetic portion 11, and the center magnetic portion 11 and the side magnetic portion 12 are spaced apart to define a magnetic gap 1a.

The center magnetic portion 11 comprises three first sub-center magnets 111 and a center magnetic conduction plate 113. The center magnetic conduction plate 113 comprises a supporting portion 1131 extending along the second direction (horizontal x-direction) and an extension portion 1132 extending along the first direction (vertical z-direction). Two ends of the extension portion 1132 are respectively connected to the supporting portion 1131 and the body portion 131. The extension portion 1132 is two in number and is provided at two ends of the supporting portion 1131 in the third direction (horizontal y-direction). The three first sub-center magnets 111 are spaced apart along the second direction, the end of each first sub-center magnet 111 away from the second vibration system 3 is connected to the supporting portion 1131, and two adjacent first sub-center magnets 111 are spaced apart to form a spacing portion 1b. The side magnetic portion 12 comprises a side magnet 121 and a side magnetic conduction plate 122 provided on a side of the side magnet 121 away from the second vibration system 3. Both the side magnet 121 and the plurality of first sub-center magnets 111 are magnetized along the first direction, and the magnetization directions between the adjacent side magnet 121 and first sub-center magnet 111, and between two adjacent first sub-center magnets 111, are all opposite. The magnetic yoke 13 comprises a body portion 131 and a hollowed-out hole 132 formed in the body portion 131, the side magnet 121 is provided on the body portion 131, and the two ends of the extension portion 1132 are respectively connected to the supporting portion 1131 and the body portion 131. Along the first direction, the plurality of first sub-center magnets 111 are opposed to the hollowed-out hole 132.

The first vibration system 2 vibrates along the first direction, and comprises a diaphragm assembly 21 and a voice coil 22. The diaphragm assembly 21 comprises a diaphragm 211 and a dome 212 provided on the diaphragm 211. One end of the voice coil 22 is fixed to the dome 212, and the other end of the voice coil 22 is inserted into the magnetic gap 1a. The side magnetic conduction plate 122 comprises a horizontally extending first plate body 1221 and a vertically extending second plate body 1222. The first plate body 1221 is provided on a side of the side magnet 121 away from the second vibration system 3. One end of the second plate body 1222 is connected to the first plate body 1221, and the other end of the second plate body 1222 extends along the first direction. Both ends of the diaphragm 211 are fixed to the second plate body 1222. The second plate body 1222 can be integrally injection molded with the plastic basket 5 of the vibration sound-producing unit 100, meaning the second plate body 1222 can serve as a part of the bracket 4, and the edge of the diaphragm 211 can be fixed to the bracket 4. Here, the corrugation portion of the diaphragm 211 extends along the first direction towards the side close to the side magnetic portion 12. The first plate body 1221 is provided with a recessed portion 122a arranged corresponding to the corrugation portion.

The second vibration system 3 vibrates along the second direction, and comprises an elastic connecting member 31 and a vibrator assembly 32. The body portion 131 of the magnetic yoke 13 is formed as a rectangular structure. A pair of diagonal positions of the body portion 131 is provided with supporting frames 133. The supporting frame 133 is formed as a plate-like structure. One end of the supporting frame 133 is connected to the body portion 131, and the other end of the supporting frame 133 extends along the first direction away from the body portion 131. The two ends of the elastic connecting member 31 are respectively connected to the vibrator assembly 32 and the supporting frame 133. Thereby, the magnetic circuit system 1 can suspend the vibrator assembly 32. The vibrator assembly 32 comprises a counterweight 321 and two driving coils 322 provided on the counterweight 321. Each driving coil 322 has two long sides 3221 arranged opposite to each other and two short sides 3222 arranged opposite to each other. The two short sides 3222 are provided on two sides along the length direction of the long sides 3221. Each end of each short side 3222 is connected to a long side 3221. Thereby, the two short sides 3222 and the two long sides 3221 cooperatively define a center hole. Along the first direction, each center hole is arranged in one-to-one correspondence with each spacing portion 1b, and the two long sides 3221 are respectively opposed to two adjacent first sub-center magnets 111.

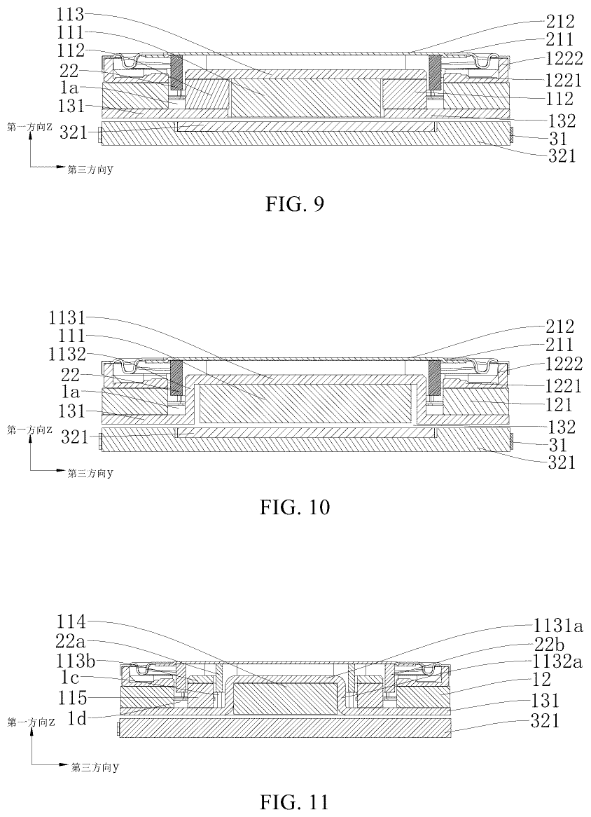

As shown in FIGS. 1 and 9, in some embodiments of the present disclosure, the side magnetic portion 12 can comprise a side magnet 121. The center magnetic portion 11 further comprises second sub-center magnets 112 provided on two sides of the plurality of first sub-center magnets 111 in the third direction. The third direction is perpendicular to both the first direction and the second direction. The side magnet 121, the first sub-center magnets 111, and the second sub-center magnets 112 are all magnetized along the first direction. Along the second direction, the magnetization directions between the adjacent side magnet 121 and first sub-center magnet 111, and between two adjacent first sub-center magnets 111, are all opposite. Along the third direction, the magnetization directions between the adjacent side magnet 121 and second sub-center magnet 112 are all opposite.

Specifically, the second direction and the third direction can be in the same horizontal plane. For example, the second direction can be the horizontal x-direction, the third direction can be the horizontal y-direction, and the first direction can be the vertical z-direction. Here, the center magnetic portion 11 comprises a plurality of first sub-center magnets 111 arranged spaced apart along the second direction and second sub-center magnets 112 arranged spaced apart along the third direction. Here, the side magnet 121, the first sub-center magnets 111, and the second sub-center magnets 112 are all magnetized along the first direction. For example, the first direction can be the vertical z-direction. Along the second direction, for the adjacent side magnet 121 and first sub-center magnet 111, one of the two is magnetized from top to bottom and the other from bottom to top; and for two adjacent first sub-center magnets 111, one of the two is magnetized from top to bottom and the other from bottom to top. Similarly, along the third direction, for the adjacent side magnet 121 and second sub-center magnet 112, one of the two is magnetized from top to bottom and the other from bottom to top.

Thereby, through the above arrangement, it is possible for the voice coil 22 to fully cut the magnetic field lines in the magnetic gap 1a formed between the side magnetic portion 12 and the center magnetic portion 11, and also possible for the driving coil 322 to fully cut the magnetic field lines in the spacing portion 1b formed between two adjacent first sub-center magnets 111, ensuring the sound-producing and vibration effects of the vibration sound-producing unit 100.

In some embodiments of the present disclosure, the center magnetic portion 11 further comprises a center magnetic conduction plate 113. The sides of the plurality of first sub-center magnets 111 and the second sub-center magnets 112 away from the second vibration system 3 are all connected to the center magnetic conduction plate 113. The magnetic yoke 13 comprises a body portion 131 and a hollowed-out hole 132 formed in the body portion 131. The side magnet 121 and the second sub-center magnets 112 are all provided on the body portion 131. Along the first direction, the hollowed-out hole 132 is at least partially opposed to the driving coil 322.

Specifically, the center magnetic conduction plate 113 can not only function to gather magnetic field lines, but can also assemble the plurality of first sub-center magnets 111 and second sub-center magnets 112 together. Here, the side magnet 121 and the second sub-center magnets 112 can all be fixed to the body portion 131 of the magnetic yoke 13. Thereby, the magnetic yoke 13 can support the center magnetic portion 11 and the side magnetic portion 12, and also can have a magnetic gathering effect, ensuring the magnetic field strength corresponding to the first vibration system 2. The hollowed-out hole 132 is formed in the body portion 131 of the magnetic yoke 13. The hollowed-out hole 132 can be opposed to a part of the driving coil 322 or the entire driving coil 322, thereby ensuring that the driving coil 322 can successfully cut the magnetic field lines, thus ensuring the vibration effect of the second vibration system 3.

In some embodiments of the present disclosure, the projections along the first direction of the plurality of first sub-center magnets 111 can all be located inside the perimeter of the hollowed-out hole 132, thereby ensuring the number of magnetic field lines passing through the hollowed-out hole 132 and thus ensuring the vibration effect of the second vibration system 3.

Furthermore, along the first direction, the plurality of first sub-center magnets 111 all extend into the hollowed-out hole 132, thereby reducing the distance between the center magnetic portion 11 and the driving coil 322, thus increasing the strength of the magnetic field lines acting on the driving coil 322, and thereby improving the vibration effect of the second vibration system 3.

Furthermore, there can be a plurality of driving coils 322 and one hollowed-out hole 132. The hollowed-out hole 132 is arranged corresponding to the plurality of driving coils 322, thereby simplifying the processing procedure of the hollowed-out hole 132 and improving processing efficiency. Certainly, there can be a plurality of driving coils 322 and also a plurality of hollowed-out holes 132. The plurality of hollowed-out holes 132 are arranged in one-to-one correspondence with the plurality of driving coils 322, thereby relatively reducing the opening area of the magnetic yoke 13, thus improving the magnetic gathering effect and structural strength of the magnetic yoke 13.

Below, the vibration sound-producing unit 100 according to a specific embodiment of the present disclosure is described in detail with reference to FIGS. 1, 5, and 9.

As shown in FIGS. 1, 5, and 9, the vibration sound-producing unit 100 comprises: a magnetic circuit system 1, a first vibration system 2, and a second vibration system 3.

Here, the first vibration system 2 and the second vibration system 3 are respectively provided on opposite sides of the magnetic circuit system 1. The magnetic circuit system 1 comprises a magnetic yoke 13, and a center magnetic portion 11 and a side magnetic portion 12 provided on the magnetic yoke 13. The side magnetic portion 12 is provided on an outer side of the center magnetic portion 11, and the center magnetic portion 11 and the side magnetic portion 12 are spaced apart to define a magnetic gap 1a.

The center magnetic portion 11 comprises three first sub-center magnets 111, two second sub-center magnets 112, and a center magnetic conduction plate 113. The three first sub-center magnets 111 are spaced apart along the second direction (horizontal x-direction). The two second sub-center magnets 112 are provided on two sides of the three first sub-center magnets 111 in the third direction (horizontal y-direction). The end of each first sub-center magnet 111 and each second sub-center magnet 112 away from the second vibration system 3 is connected to the center magnetic conduction plate 113. Two adjacent first sub-center magnets 111 are spaced apart to form a spacing portion 1b. The side magnetic portion 12 comprises a side magnet 121 and a side magnetic conduction plate 122 provided on a side of the side magnet 121 away from the second vibration system 3. The magnetic yoke 13 comprises a body portion 131 and a hollowed-out hole 132 formed in the body portion 131. The side magnet 121 and the second sub-center magnets 112 are all provided on the body portion 131. Along the first direction (vertical z-direction), the plurality of first sub-center magnets 111 are opposed to the hollowed-out hole 132. Here, the side magnet 121, the first sub-center magnets 111, and the second sub-center magnets 112 are all magnetized along the first direction. Along the second direction, the magnetization directions between the adjacent side magnet 121 and first sub-center magnet 111, and between two adjacent first sub-center magnets 111, are all opposite. Along the third direction, the magnetization directions between the adjacent side magnet 121 and second sub-center magnet 112 are all opposite.

The first vibration system 2 vibrates along the first direction, and comprises a diaphragm assembly 21 and a voice coil 22. The diaphragm assembly 21 comprises a diaphragm 211 and a dome 212 provided on the diaphragm 211. One end of the voice coil 22 is fixed to the dome 212, and the other end of the voice coil 22 is inserted into the magnetic gap 1a. The side magnetic conduction plate 122 comprises a horizontally extending first plate body 1221 and a vertically extending second plate body 1222. The first plate body 1221 is provided on a side of the side magnet 121 away from the second vibration system 3. One end of the second plate body 1222 is connected to the first plate body 1221, and the other end of the second plate body 1222 extends along the first direction. Both ends of the diaphragm 211 are fixed to the second plate body 1222. The second plate body 1222 can be integrally injection molded with the plastic basket 5 of the vibration sound-producing unit 100, meaning the second plate body 1222 can serve as a part of the bracket 4, and the edge of the diaphragm 211 can be fixed to the bracket 4. Here, the corrugation portion of the diaphragm 211 extends along the first direction towards the side close to the side magnetic portion 12. The first plate body 1221 is provided with a recessed portion 122a arranged corresponding to the corrugation portion.

The second vibration system 3 vibrates along the second direction, and comprises an elastic connecting member 31 and a vibrator assembly 32. The body portion 131 of the magnetic yoke 13 is formed as a rectangular structure. A pair of diagonal positions of the body portion 131 is provided with supporting frames 133. The supporting frame 133 is formed as a plate-like structure. One end of the supporting frame 133 is connected to the body portion 131, and the other end of the supporting frame 133 extends along the first direction away from the body portion 131. The two ends of the elastic connecting member 31 are respectively connected to the vibrator assembly 32 and the supporting frame 133. Thereby, the magnetic circuit system 1 can suspend the vibrator assembly 32. The vibrator assembly 32 comprises a counterweight 321 and two driving coils 322 provided on the counterweight 321. Each driving coil 322 has two long sides 3221 arranged opposite to each other and two short sides 3222 arranged opposite to each other. The two short sides 3222 are provided on two sides along the length direction of the long sides 3221. Each end of each short side 3222 is connected to a long side 3221. Thereby, the two short sides 3222 and the two long sides 3221 cooperatively define a center hole. Along the first direction, each center hole is arranged in one-to-one correspondence with each spacing portion 1b, and the two long sides 3221 are respectively opposed to two adjacent first sub-center magnets 111.

As shown in FIGS. 1-3, according to some embodiments of the present disclosure, the side of the counterweight 321 close to the magnetic circuit system 1 is provided with an assembly groove 321a, and the driving coil 322 is embedded in the assembly groove 321a. Thereby, it is possible to make the structure of the vibrator assembly 32 more compact. Optionally, fixing adhesive can be provided in the assembly groove 321a, and the driving coil 322 can be fixed in the assembly groove 321a by the fixing adhesive. It needs to be explained that the structural design of the counterweight 321 is not limited to this. For example, the counterweight 321 may also not be provided with an assembly groove 321a, and the driving coil 322 can be adhered to the outer surface of the counterweight 321.

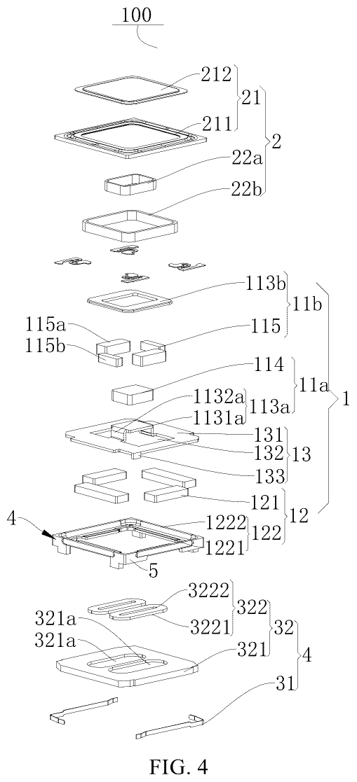

As shown in FIGS. 4 and 7, according to some embodiments of the present disclosure, there can be a plurality of magnetic gaps 1a. The plurality of magnetic gaps 1a are coaxially arranged and sequentially spaced apart from inside to outside. There can also be a plurality of voice coils 22. The plurality of voice coils 22 are arranged in one-to-one correspondence with the plurality of magnetic gaps 1a. Thereby, the first vibration system 2 can be formed as a structure where the plurality of voice coils 22 synchronously drive the diaphragm assembly 21, thus improving the sound-producing sensitivity and loudness of the first vibration system 2 and enhancing the sound-producing effect of the vibration sound-producing unit 100.

In the specific embodiment shown in FIG. 7, the magnetic circuit system 1 comprises a center magnetic portion 11 and a side magnetic portion 12. The center magnetic portion 11 comprises a first sub-center magnetic portion 11a and a second sub-center magnetic portion 11b. The second sub-center magnetic portion 11b is provided on an outer side of the first sub-center magnetic portion 11a and is spaced apart from the first sub-center magnetic portion 11a to form a first sub-magnetic gap 1c. The side magnetic portion 12 is provided on an outer side of the second sub-center magnetic portion 11b and is spaced apart from the second sub-center magnetic portion 11b to form a second sub-magnetic gap 1d. The first vibration system 2 comprises a diaphragm assembly 21, a first sub-voice coil 22a, and a second sub-voice coil 22b. One end of the first sub-voice coil 22a and one end of the second sub-voice coil 22b are respectively connected to the diaphragm assembly 21. The other end of the first sub-voice coil 22a is inserted into the first sub-magnetic gap 1c, and the other end of the second sub-voice coil 22b is inserted into the second sub-magnetic gap 1d. Thereby, the first vibration system 2 can be formed as a structure where two voice coils 22 synchronously drive one diaphragm assembly 21, thereby improving the magnetic field utilization rate of the magnetic circuit system 1 and further improving the sound-producing sensitivity of the vibration sound-producing unit 100. The driving coil 322 has two connection edges arranged opposite to each other. Along the first direction, the two connection edges are respectively opposed to the first sub-center magnetic portion 11a and the second sub-center magnetic portion 11b. Certainly, along the first direction, the two connection edges could also be respectively opposed to the second sub-center magnetic portion 11b and the side magnetic portion 12.

It needs to be explained that in the structure where the plurality of voice coils 22 synchronously drive the diaphragm assembly 21, the number of voice coils 22 can be selected and set according to actual usage requirements, which will not be limited in the present disclosure.

As shown in FIG. 7, in some embodiments of the present disclosure, the first sub-center magnetic portion 11a can comprise a first center magnet 114. The second sub-center magnetic portion 11b can comprise a second center magnet 115 provided on a periphery of the first center magnet 114. The side magnetic portion 12 can comprise a side magnet 121 provided on a periphery of the second sub-center magnetic portion 11b. The first center magnet 114, the second center magnet 115, and the side magnet 121 are all magnetized along the first direction (vertical z-direction). Along the second direction (horizontal x-direction), the magnetization directions between the adjacent first center magnet 114 and second center magnet 115, and between the adjacent second center magnet 115 and side magnet 121, are opposite. Thereby, through the above arrangement, it is possible for the first sub-voice coil 22a and the second sub-voice coil 22b to fully cut the magnetic field lines in the first sub-magnetic gap 1c and the second sub-magnetic gap 1d, and also possible for the driving coil 322 to fully cut the magnetic field lines between the adjacent first sub-center magnetic portion 11a and second sub-center magnetic portion 11b, ensuring the sound-producing and vibration effects of the vibration sound-producing unit 100.

Optionally, as shown in FIG. 4, the first center magnet 114 can be provided as one piece. The second center magnet 115 comprises four pieces provided around the first center magnet 114. The side magnet 121 also comprises four pieces provided on an outer side of the second sub-center magnetic portion 11b. The four second center magnets 115 and the four side magnets 121 are arranged in one-to-one correspondence.

As shown in FIG. 15, in some embodiments of the present disclosure, the second center magnets 115 at the two ends of the first center magnet 114 in the second direction (e.g., horizontal x-direction) are first magnets 115a. The second center magnets 115 at the two ends of the first center magnet 114 in the third direction (e.g., horizontal y-direction) are second magnets 115b. The third direction is perpendicular to both the first direction (e.g., vertical z-direction) and the second direction. A volume of the first magnet 115a is greater than that of the second magnet 115b. It can be understood that since the long sides 3221 of the driving coil 322 extend along the third direction, the magnetic field acting on the driving coil 322 mainly comes from the first center magnet 114 and the second center magnets 115 (first magnets 115a) located on the two sides of the first center magnet 114 in the second direction. By setting the volume of the first magnet 115a to be greater than that of the second magnet 115b, it is possible to increase the strength of the magnetic field acting on the driving coil 322, thereby improving the haptic performance of the vibration sound-producing unit 100.

Furthermore, as shown in FIGS. 7, 11, and 14, the second sub-center magnetic portion 11b further comprises a second center magnetic conduction plate 113b provided on a side of the second center magnet 115 close to the diaphragm assembly 21. The second center magnetic conduction plate 113b is formed as a closed ring structure, which facilitates centralized assembly of the first and second magnets and thereby improves assembly efficiency.

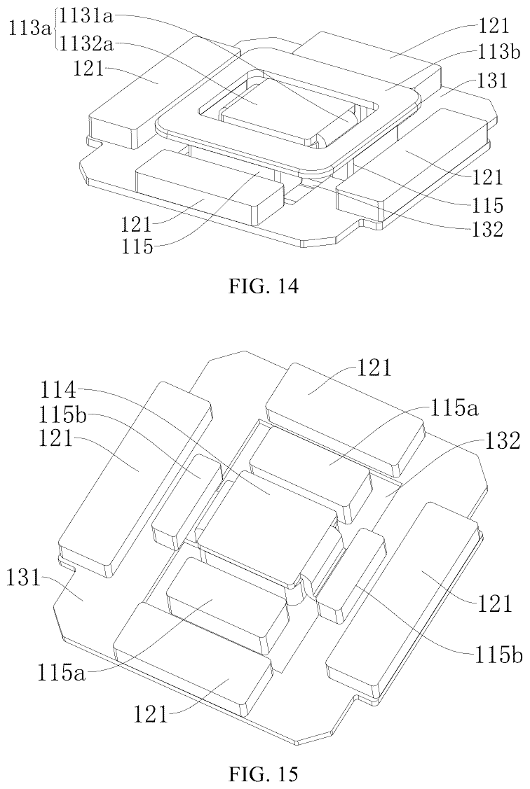

As shown in FIGS. 7 and 14, in some embodiments of the present disclosure, the magnetic yoke 13 can comprise a body portion 131 and a hollowed-out hole 132 formed in the body portion 131. Along the first direction (e.g., vertical z-direction), the hollowed-out hole 132 is at least partially opposed to the driving coil 322. The side magnetic portion 12 and the second sub-center magnetic portion 11b are both provided on the body portion 131. The first sub-center magnetic portion 11a comprises a first center magnet 114 and a first center magnetic conduction plate 113a. The first center magnetic conduction plate 113a can comprise a supporting plate 1131a and an extension plate 1132a provided on an outer side of the supporting plate. At least part of the extension plate 1132a extends along the first direction. Two ends of the extension plate 1132a are respectively connected to the supporting plate 1131a and the body portion 131. The supporting plate 1131a is opposed to the hollowed-out hole 132. The first center magnet 114 is provided on the supporting plate 1131a.

Specifically, the magnetic yoke 13 can be used to support the first sub-center magnetic portion 11a, the second sub-center magnetic portion 11b, and the side magnetic portion 12. Here, the second sub-center magnetic portion 11b and the side magnetic portion 12 are provided on the body portion 131 of the magnetic yoke 13. Since the extension plate 1132a of the first center magnetic conduction plate 113a is connected to the body portion 131, the magnetic yoke 13 supports the first sub-center magnetic portion 11a through the extension plate 1132a. It can be understood that since the magnetic yoke 13 is provided with the hollowed-out hole 132 opposed to the driving coil 322 along the first direction, wherein the hollowed-out hole 132 can be opposed to a part of the driving coil 322 or the entire driving coil 322, it ensures that the driving coil 322 can successfully cut the magnetic field lines, thus ensuring the vibration effect of the second vibration system 3.

Optionally, the supporting plate 1131a can extend horizontally. The first center magnet 114 is provided on a side of the supporting plate 1131a close to the hollowed-out hole 132. The extension plate 1132a can extend vertically. The two ends of the extension plate 1132a are respectively connected to the supporting plate 1131a and the body portion 131.

As shown in FIG. 11, in some embodiments of the present disclosure, along a third direction perpendicular to both the first direction and the second direction, the extension plate 1132a is located on opposite sides of the supporting plate 1131a. The second sub-center magnetic portion 11b is spaced apart from the supporting plate 1131a to define a part of the first sub-magnetic gap 1c. Specifically, the second direction and the third direction can be in the same horizontal plane. For example, the first direction can be the vertical z-direction, the second direction can be the horizontal x-direction, and the third direction can be the horizontal y-direction. Here, the extension plate 1132a can be two in number. The two extension plates 1132a can be provided on two sides of the supporting plate 1131a in the third direction, thereby connecting the supporting plate 1131a and the magnetic yoke 13 together, resulting in a relatively simple structural design. Here, the second sub-center magnetic portion 11b can be spaced apart from the supporting plate 1131a to define a part of the first sub-magnetic gap 1c, and the second sub-center magnetic portion 11b can also be spaced apart from the first center magnet 114 on both sides along the second direction to define another part of the first sub-magnetic gap 1c.

As shown in FIG. 15, in some embodiments of the present disclosure, the second sub-center magnetic portion 11b can comprise a second center magnet 115 provided on a periphery of the first center magnet 114. The second center magnets 115 on the two sides of the first sub-center magnetic portion 11a in the third direction (e.g., horizontal y-direction) are provided on the body portion 131. The second center magnets 115 on the two sides of the first sub-center magnetic portion 11a in the second direction (e.g., horizontal x-direction) are opposed to the hollowed-out hole 132 along the first direction. Thereby, it is possible to increase the area of the second center magnets 115 opposed to the hollowed-out hole 132, thus ensuring the number of magnetic field lines acting on the driving coil 322 and ensuring the vibration effect of the second vibration system 3.

As shown in FIG. 14, in some embodiments of the present disclosure, the second sub-center magnetic portion 11b can comprise a second center magnetic conduction plate 113b provided on a side of the second center magnet 115 away from the body portion 131. The second center magnetic conduction plate 113b is formed as a ring structure and is sleeved on an outer side of the supporting plate 1131a. Thereby, the second center magnets 115 located on the periphery of the first center magnet 114 are all connected to the side of the second center magnetic conduction plate 113b away from the diaphragm assembly 21. The second center magnets 115 located on the two sides of the first sub-center magnetic portion 11a in the third direction are provided on the body portion 131. The bottoms of the second center magnets 115 located on the two sides of the first sub-center magnetic portion 11a in the second direction are opposed to the hollowed-out hole 132 along the first direction. Through the above arrangement, the second center magnetic conduction plate 113b can suspend the second center magnets 115 located on the two sides of the first sub-center magnetic portion 11a in the second direction, resulting in a simple and ingenious structural design, which not only meets the magnetic force requirements for the first sub-voice coil 22a but also ensures the number of magnetic field lines acting on the driving coil 322, thus ensuring the vibration effect of the second vibration system 3.

In some embodiments of the present disclosure, the projections along the first direction (e.g., vertical z-direction) of the first center magnet 114 and the second center magnets 115 located on the two sides of the first sub-center magnetic portion 11a in the second direction (e.g., horizontal x-direction) are located inside the perimeter of the hollowed-out hole 132. Thereby, it is possible to ensure the number of magnetic field lines passing through the hollowed-out hole 132, thus ensuring the vibration effect of the second vibration system 3.

Furthermore, along the first direction, the first center magnet 114 and the second center magnets 115 located on the two sides of the first sub-center magnetic portion 11a in the second direction all extend into the hollowed-out hole 132, which may reduce the distance between the first sub-center magnetic portion 11a and the second sub-center magnetic portion 11b, and the driving coil 322, thus may increase the magnetic field strength acting on the driving coil 322, and thereby may improve the vibration effect of the second vibration system 3.

In a specific embodiment of the present disclosure, the first center magnetic conduction plate 113a and the magnetic yoke 13 are formed as an integrally molded structure, which may simplify the structural design of the magnetic circuit system 1, and simplify the assembly process. For example, the first center magnetic conduction plate 113a and the magnetic yoke 13 can be formed as an integral stamping part. Certainly, it can be understood that the first center magnetic conduction plate 113a and the magnetic yoke 13 can also be formed as separate components, and the extension plate 1132a of the first center magnetic conduction plate 113a and the body portion 131 of the magnetic yoke 13 can be assembled together by means such as laser welding.

As shown in FIG. 18, a vibration sound-producing module 200 according to an embodiment of the second aspect of the present disclosure comprises a housing 201 and the vibration sound-producing unit 100 according to the above embodiments of the present disclosure. The vibration sound-producing unit 100 is provided inside the housing 201, and the first end of the stationary assembly is connected to an inner wall of the housing 201. Thereby, the vibration sound-producing unit 100 can be fixed inside the housing 201, and the stationary assembly can suspend the vibrator assembly 32 of the second vibration system 3 inside the housing 201.

It can be understood that in some embodiments, in the case where the diaphragm 211 of the first vibration system 2 is fixed to the end face of the first end of the stationary assembly, the end face of the first end of the stationary assembly, after fixing the diaphragm 211, is then connected to the inner wall of the housing 201. Or, in some other embodiments, the end face of the first end of the stationary assembly is successively connected to the diaphragm 211 and a front cover, and the front cover serves as a protective member. In this case, the first end of the stationary assembly, after fixing the diaphragm 211 and the front cover, is then connected to the inner wall of the housing 201.

Typically, the vibration sound-producing unit is provided inside the housing 201 of the vibration sound-producing module 200, the internal space of the housing 201 is divided into a front acoustic cavity and a rear acoustic cavity, the front acoustic cavity is in communication with a sound outlet on the housing 201 to guide sound out, and the rear acoustic cavity is in communication with the space behind the diaphragm 211 for adjusting the low-frequency performance of the product.

The vibration sound-producing module 200 according to the embodiment of the second aspect of the present disclosure, by arranging the above vibration sound-producing unit 100, allows the first vibration system 2 and the second vibration system 3 of the vibration sound-producing unit 100 to share one magnetic circuit system 1, resulting in a relatively compact structure, thereby allowing an increase in the acoustic cavity volume of the vibration sound-producing module 200. Moreover, the elastic connecting member 31 of the above vibration sound-producing unit 100 is respectively connected to the stationary assembly and the vibrator assembly 32, and it is thus possible to achieve modular and standardized design, thereby improving the assembly efficiency of the vibration sound-producing module 200.

An electronic device according to an embodiment of the third aspect of the present disclosure comprises the vibration sound-producing module 200 according to the above embodiments of the present disclosure. Optionally, the electronic device can be a mobile phone, a PAD, a laptop computer, etc.

In the electronic device according to the embodiment of the third aspect of the present disclosure, by arranging the above vibration sound-producing module 200, the vibration sound-producing module 200 is compact in the structural design, occupies a small assembly space, also has good sound-producing effects and vibration effects to thus meet the slim and lightweight design requirements of the electronic device, and furthermore, may enable the electronic device to have both good sound quality and vibration feedback effects, enhancing the product market competitiveness of the electronic device.

In the description of the present disclosure, it should be understood that, an orientation or positional relationship indicated by terms “center”, “longitudinal”, “lateral”, “length”, “width”, “thickness”, “upper”, “lower”, “front”, “back”, “left”, “right”, “vertical”, “horizontal”, “top”, “bottom”, inner”, “outer”, “clockwise”, “counterclockwise”, “axial”, “radial”, “circumferential” is based on orientations or positional relationships shown in the accompanying drawings, and is only for convenience of describing the present disclosure and simplifying the description, rather than indicating or implying that a device or element referred to must be provided with a particular orientation, be constructed and operate in a particular orientation, and therefore should not be understood as a limitation to the present disclosure. In addition, a feature designated as “first”, “second” may expressly or implicitly include one or more of those features. In a description of the present disclosure, “a plurality” means two or more than two, unless expressly and specifically defined otherwise.

In the description of the present disclosure, it should be explained that unless expressly specified and limited otherwise, terms “installed”, “communicated”, and “connected” should be interpreted in a broad sense, for example, it can be a fixed connection, a detachable connection, or an integrated; it can be a mechanical connection or an electrical connection; it can be directly connected, or indirectly connected through an intermediate medium, and it can be an internal communication between two elements. For those of ordinary skill in the art, specific meanings of the above terms in the present disclosure can be understood according to specific situations.

In the description of the present specification, the reference terms “one embodiment”, “some embodiments”, “illustrative embodiment”, “example”, “specific example”, or “some examples” are intended to indicate that specific features, structures, materials, or characteristics described in connection with the embodiment or example are included in at least one embodiment or example of the present disclosure. In the present specification, the illustrative expressions of the above terms do not necessarily refer to the same embodiment or example. Furthermore, the specific features, structures, materials, or characteristics described may be combined in any one or more embodiments or examples in a suitable manner.

Although embodiments of the present disclosure have been shown and described, it will be understood by those skilled in the art that various changes, modifications, substitutions, and variations may be made to these embodiments without departing from the principles and purpose of the present disclosure, the scope of which is defined by the claims and their equivalents.

1. A vibration sound-producing unit, comprising:
a stationary assembly comprising a bracket and a magnetic circuit system fixed to the bracket, the magnetic circuit system having a plurality of magnetic gaps that are coaxially arranged and sequentially spaced apart from inside to outside; and
a first vibration system and a second vibration system, the first vibration system and the second vibration system being respectively provided on opposite sides of the stationary assembly and respectively fixed to opposite ends of the stationary assembly,
wherein the first vibration system is configured to vibrates along a first direction, is fixed to a first end of the stationary assembly, and comprises a diaphragm assembly and a plurality of voice coils, a first end of each voice coil being connected to the diaphragm assembly, and a second end of each voice coil being inserted into a corresponding one of the plurality of magnetic gaps in a one-to-one correspondence;
the second vibration system is configured to vibrates along a second direction perpendicular to the first direction, and comprises an elastic connecting member and a vibrator assembly, two ends of the elastic connecting member being respectively connected to the vibrator assembly and a second end of the stationary assembly, the vibrator assembly comprising a counterweight and a driving coil provided on the counterweight, the magnetic circuit system being correspondingly arranged with the driving coil to drive the vibrator assembly to vibrate.

2. The vibration sound-producing unit according to claim 1, wherein the two ends of the elastic connecting member are respectively connected to the vibrator assembly and the bracket, the bracket has a first mounting portion extending to the second end of the stationary assembly, and the elastic connecting member is fixedly connected to the first mounting portion.

3. The vibration sound-producing unit according to claim 1, wherein the two ends of the elastic connecting member are respectively connected to the vibrator assembly and the magnetic circuit system.

4. The vibration sound-producing unit according to claim 1, wherein the magnetic circuit system comprises a magnetic yoke, and a center magnetic portion and a side magnetic portion respectively provided on the magnetic yoke, and the side magnetic portion is provided on an outer side of the center magnetic portion and is spaced apart from the center magnetic portion to define a magnetic gap.

5. The vibration sound-producing unit according to claim 4, wherein the side magnetic portion comprises a side magnet and a side magnetic conduction plate provided on a side of the side magnet distal to the second vibration system, the side magnetic conduction plate has a second mounting portion extending to the second end of the stationary assembly, and the elastic connecting member is fixedly connected to the second mounting portion;
or, the elastic connecting member is fixedly connected to a side edge of the magnetic circuit system.

6. The vibration sound-producing unit according to claim 4, wherein the elastic connecting member is connected to the magnetic yoke.

7. The vibration sound-producing unit according to claim 6, wherein the magnetic yoke comprises a body portion and at least a supporting frame provided at two ends of the body portion, a first end of the elastic connecting member is connected to one of the supporting frames, and a second end of the elastic connecting member is connected to the counterweight.

8. The vibration sound-producing unit according to claim 7, wherein the body portion is formed as a rectangular structure, and two supporting frames are respectively provided at diagonal positions of the body portion.

9. The vibration sound-producing unit according to claim 8, wherein the elastic connecting member is provided with a first elastic connection portion extending along the second direction and a second elastic connection portion extending along a third direction, the third direction is perpendicular to both the first direction and the second direction, a first of the first elastic connection portion and the second elastic connection portion is connected to one of the supporting frames, and a second of the first elastic connection portion and the second elastic connection portion is connected to the counterweight.

10. The vibration sound-producing unit according to claim 4, wherein the center magnetic portion comprises a first sub-center magnetic portion and a second sub-center magnetic portion, the second sub-center magnetic portion is provided on an outer side of the first sub-center magnetic portion and is spaced apart from the first sub-center magnetic portion to form a first sub-magnetic gap, the side magnetic portion is provided on an outer side of the second sub-center magnetic portion and is spaced apart from the second sub-center magnetic portion to form a second sub-magnetic gap, the plurality of voice coils comprise a first sub-voice coil and a second sub-voice coil, the first sub-voice coil is inserted into the first sub-magnetic gap, and the second sub-voice coil is inserted into the second sub-magnetic gap.

11. The vibration sound-producing unit according to claim 10, wherein the first sub-center magnetic portion comprises a first center magnet, the second sub-center magnetic portion comprises at least a second center magnet provided on a periphery of the first center magnet, the side magnetic portion comprises a side magnet provided on a periphery of the second sub-center magnetic portion, the first center magnet, the second center magnet, and the side magnet are all-magnetized along the first direction, and along the second direction, magnetization directions between the adjacent first center magnet and second center magnet and between the adjacent second center magnet and side magnet are opposite.

12. The vibration sound-producing unit according to claim 11, wherein second center magnets at two ends of the first center magnet along the second direction are first magnets, second center magnets at two ends of the first center magnet along a third direction are second magnets, the third direction is perpendicular to both the first direction and the second direction, and a volume of the first magnet is greater than that of the second magnet.

13. The vibration sound-producing unit according to claim 10, wherein the magnetic yoke comprises a body portion and a hollowed-out hole formed in the body portion, the hollowed-out hole is at least partially opposed to the driving coil along the first direction, both the side magnetic portion and the second sub-center magnetic portion are provided on the body portion, the first sub-center magnetic portion comprises a first center magnet and a first center magnetic conduction plate, the first center magnetic conduction plate comprises a supporting portion and an extension portion provided on an outer side of the supporting portion, at least a part of the extension portion extends along the first direction, two ends of the extension portion are respectively connected to the supporting portion and the body portion, the supporting portion is opposed to the hollowed-out hole, and the first center magnet is provided on the supporting portion.

14. The vibration sound-producing unit according to claim 13, wherein along a third direction perpendicular to both the first direction and the second direction, the extension portion is located on opposite sides of the supporting portion, and the second sub-center magnetic portion is spaced apart from the extension portion to define a part of the first sub-magnetic gap.

15. The vibration sound-producing unit according to claim 14, wherein the second sub-center magnetic portion comprises a second center magnet provided on a periphery of the first center magnet, second center magnets on two sides of the first sub-center magnetic portion along the third direction are provided on the body portion, and second center magnets on two sides of the first sub-center magnetic portion along the second direction are opposed to the hollowed-out hole along the first direction.

16. The vibration sound-producing unit according to claim 15, wherein the second sub-center magnetic portion comprises a second center magnetic conduction plate provided on a side of the second center magnet distal to the body portion, and the second center magnetic conduction plate is formed as a ring structure and is sleeved on an outer side of the supporting portion.

17. The vibration sound-producing unit according to claim 15, wherein projections along the first direction of the first center magnet and the second center magnets located on two sides of the first sub-center magnetic portion along the second direction are located inside a perimeter of the hollowed-out hole.

18. The vibration sound-producing unit according to claim 17, wherein along the first direction, the first center magnet and the second center magnets located on two sides of the first sub-center magnetic portion along the second direction both extend into the hollowed-out hole.

19. The vibration sound-producing unit according to claim 10, wherein the driving coil has two connection edges arranged opposite to each other, and along the first direction, the two connection edges are respectively opposed to the first sub-center magnetic portion and the second sub-center magnetic portion;
and/or, the two connection edges are respectively opposed to the second sub-center magnetic portion and the side magnetic portion.

20. A vibration sound-producing module, comprising:
a housing; and
the vibration sound-producing unit according to claim 1,
wherein the vibration sound-producing unit is provided inside the housing, and a first end of the stationary assembly being connected to an inner wall of the housing.

21. An electronic device, comprising the vibration sound-producing module according to claim 20.
